(19) United States
(12) Patent Application Publication
(10) Pub. No.: US 2012/0259781 A1
(43) Pub. Date: Oct. 11, 2012

(54) BROKER-MEDIATED PAYMENT SYSTEMS AND METHODS

(76) Inventors: Charles T. Fote, Cherry Hill, CO (US); Charles O'Rourke, Greenwood Village, CO (US); Yaacov Apelbaum, Sayville, NY (US)

(21) Appl. No.: 13/442,309

(22) Filed: Apr. 9, 2012

Related U.S. Application Data
(60) Provisional application No. 61/472,953, filed on Apr. 7, 2011.

(51) Int. Cl. G06Q 20/40

(52) U.S. Cl. 705/44

(57) ABSTRACT

In certain embodiments of systems and methods for conducting payment transactions between a payer and a payee, the payer selects one or more payment sources from various funding sources and accounts available to the payer, and instructs a payment broker's server to perform payment authorization and/or payment routing and clearing services on the payer's behalf. The payment broker's server notifies the payer and/or the payee of the payment authorization status and, if approved, instructs the funding source to send the payment to or for the payee without divulging the payer-selected funding source or account to the payee.

### CROSS-REFERENCE TO RELATED APPLICATION

This application claims priority to and the benefit of, and incorporates herein by reference in its entirety, U.S. Provisional Patent Application No. 61/472,953 which was filed on Apr. 7, 2011.

### FIELD OF THE INVENTION

The invention generally relates to systems and methods for payer-initiated and payer-controlled payment transactions where a payer wishes to make a payment to or for the benefit of a payee.

### BACKGROUND OF THE INVENTION

Today's payment systems and methods are dominated by legacy cash-based, check-based or credit or debit account or card payment concepts, and implementations based upon those concepts are manifest in typical point of sale (“POS”) and electronic payment environments. Payment transactions handled by these legacy systems can relate to the payment for goods or services purchased by the payer (whether in traditional POS transactions or otherwise) or to other types of payments made by the payer.

Despite the advances in the supporting technology, the primary model for payment transactions has not changed substantially. For instance, the main relationships in the current purchasing/payment model using checks or credit or debit accounts or cards are between (a) a merchant and an acquiring financial institution, and (b) a purchaser and an issuing financial institution. The financial institutions are at the center of this business model and they control the current environments found in most payment situations. Therefore, the payee and the payer ordinarily are forced to accept and use the financial institutions' systems and methods, which may be opposed to the needs or desires of the payee and the payment wishes of the payer.

Security and privacy are also of concern in the current payment models as well. The legacy systems and methods were not designed to deal with the security issues that have arisen as the systems have evolved for use in mail and telephone order, and later electronic commerce situations, and especially those that include buying and selling goods or services over wireless telecommunications systems or wired networks such as the Internet. None-the-less, technology infrastructures (e.g., networks, servers, computer systems, etc.) have evolved to support the growth in payment transactions and now incorporate additional functionality to improve security and reduce privacy weaknesses in the original implementations. Payment Card Industry Data Security Standard (PCI DSS) is an example of after-the-fact rules and processes that attempt to patch the security and privacy weaknesses in legacy payment systems. To accommodate these new security and privacy policies, existing servers and network infrastructures must oftentimes undergo extensive, often massive, change.

Modifying and patching these legacy systems is costly, often inefficient and to an extent ineffective as additional security and privacy weaknesses can arise as a result of changing existing payment processing servers and networks. In addition, the restrictions of existing payment systems do not necessarily promote the development or growth of new payment services, payment types or payment devices. Further, the financial institutions that own and operate the existing systems can be resistant to changes in those systems or related revenue models, and thus can impede innovation rather than promote it.

Accordingly, there is a need and desire for new payment systems and methods that will address the many shortcomings of the current systems and methods, provide greater flexibility in payment transactions between payers and payees and in many cases bring payers and payees closer together into a relationship that is otherwise natural for them.

### BRIEF SUMMARY OF THE INVENTION

In accordance with various embodiments of the invention, payer-initiated and payer-controlled payment transactions utilize a mediating broker entity involving one or more servers that the broker entity owns, leases or controls; the broker entity, through its server(s), acts for and at the direction of the payer to cause payment(s) to be made to payee(s) without divulging the payer-selected funding source(s) and/or real account(s) to the payee. This approach is distinct from conventional payment systems and methods where the payee (e.g., a merchant) is responsible for initiating the payment authorization process and information about the payer's funding source(s) and/or real account(s) is transparent to or obtainable by the payee. Various embodiments of the invention restructure current payment systems and methods to address limitations and restrictions in the conventional model.

Various implementations of the invention may include one or more of the following features and advantages:

(a) A payment broker is created whose responsibility it is to implement and use servers that the broker entity owns, leases or controls to cause payment(s) to be made to payee(s) at the direction and instruction of the payer.

(b) As opposed to current conventional systems or methods, the selection of funding source(s) and real account(s) to be used for the payment(s), the initiation of the authorization process and the manner in which the payment(s) is/are to be made, as well as the overall control of the payment process, rests with the payer. In addition, the payer is not restricted to those payment sources or types normally advertised and accepted by a merchant or other payee. Further, the payer can also designate one or more agents or users to act for and as authorized by the payer in communicating with and instructing the payment broker so as to cause payment(s) to be made to payee(s). As but one example, a payer can authorize his or her accountant to act as his or her agent to communicate with and instruct the payment broker for or on the payer's behalf in order to cause payment(s) to be made to payee(s) from one or more funding source(s) and real account(s) of the payer.

(c) Once authorization has been obtained and the payer and/or payee so notified, the payment broker can or will guarantee the payment to the payee provided that there are no abnormal circumstances relating to the payment. The notification by the payment broker that authorization has been obtained or denied can be made without divulging the payer-selected funding source(s) or real account(s) to the payee.

(d) The payer may select one or more funding sources and real accounts that the payer would like to use for a particular payment. The selection may be any real account(s) at one or more funding sources which the payer has previously identified to the payment broker and that may result in a transfer of value (e.g., a remittance of funds) from or on behalf of and at the direction of the payer to the payee upon the completion of the payment without divulging the payer-selected funding source(s) and/or real account(s) to the payee.

(e) Although the payer may have loyalties to one funding source over others, at the time of the payment the payer's loyalty to the payee is reinforced and emphasized regardless of the funding source(s) or real account(s) used to make the payment. This reinforcement and emphasis can arise in many ways including because the payer now controls the payment transaction and the funding source(s), real account(s) and manner of payment, and also because the systems and methods described herein can result in more certainty of payment for the payee and thereby encourage the payee to provide incentives to the payer (such as discounts, coupons, value-adds, etc.) in consideration of the payer's use of the disclosed systems and methods to effect the payment.

(f) Security and privacy infrastructures may be part of the server and network architecture described herein.

(g) In various implementations a payee does not have access to or possess any of the payer's funding source or real account data or, in most cases, the method of payment; consequently, the payee's systems (e.g., where the payee is a merchant) do not need to concern themselves with any risks associated with processing or storing such data. Thus, payees are relieved of the risks and concerns that arise from possessing or storing sensitive payer data that may be subject to attacks by criminals for fraudulent use, such as by hacking, phishing, piracy or other illegal conduct.

(h) Payees that are merchants may also be able to avoid the capital cost or other expenses relating to modifying their existing POS, server and network systems to accommodate various security and privacy rules (e.g., PCI DSS) determined by funding sources and/or related associations (e.g., VISA, MasterCard, etc.)

Accordingly, in one aspect, the invention pertains to a method of facilitating a payment. The method includes the steps of: (i) at a payment brokerage server, causing an authentication of a payer; (ii) facilitating, by the brokerage server, a payer selection of one or more funding sources and one or more real accounts associated with the payer; (iii) obtaining, at the brokerage server, information identifying a payee; (iv) receiving, at the brokerage server, an instruction from the payer instructing that the payment be made to the payee from the payer-selected funding source(s) and the payer-selected real account(s); (v) obtaining, at the brokerage server, an approval from the payer-selected funding source(s) to make the payment; and (vi) facilitating, by the brokerage server, the payment from the payer-selected funding source(s) to one or more real accounts of the payee to complete the payment transaction without divulging the payer-selected funding source(s) or the payer-selected real account(s) to the payee.

In various embodiments, the method includes wherein the brokerage server communicates with the payer and/or the payee via wireless or wired network communication using a payer and/or a payee electronic device, respectively. The payer electronic device may communicate with the payee electronic device and vice versa via wireless or wired network communication.

In various embodiments, the method includes wherein the brokerage server includes or is in communication with one or more databases including multiple records for payers and payees. Each payer record includes authentication information and one or more funding sources and one or more real accounts associated with the payer. Each payee record includes at least identification information associated with the payee.

In various embodiments, the method includes wherein the brokerage server facilitates the funding or transfer of the payment from one or more payer-selected funding sources to one or more real accounts of the payment broker and from one or more real accounts of the payment broker to one or more real accounts of the payee to complete the payment transaction without divulging the payer-selected funding source(s) or the payer-selected real account(s) to the payee.

In various embodiments, the method includes wherein the brokerage server facilitates the funding or transfer of the payment from one or more payer-selected funding sources to one or more real accounts of the payment broker and from one or more real accounts of the payment broker to the payee by issuance, by the payment broker, of one or more instruments of remittance or transfer and (i) mailing the instruments to the payee, (ii) delivering the instruments to the payee or (iii) holding the instruments for pick-up by the payee in order to complete the payment transaction without divulging the payer-selected funding source(s) or the payer-selected real account(s) to the payee.

In a second aspect, the invention relates to a brokerage server for facilitating a payment.

The server includes: a communications module; an authentication module for facilitating an authentication of a payer; and a payment module for: (i) facilitating a payer selection of one or more funding sources and one or more real accounts associated with the payer; (ii) obtaining information identifying a payee, (iii) receiving an instruction from the payer instructing that the payment be made to the payee from one or more payer-selected funding sources and one or more payer-selected real accounts; (iv) obtaining an approval from the payer-selected funding source(s) to make the payment; and (v) facilitating the payment from the payer-selected funding source(s) and the payer-selected real account(s) to one or more real accounts of the payee to complete the payment transaction without divulging the payer-selected funding source(s) or the payer-selected real account(s) to the payee.

In various embodiments, the brokerage server includes a module for accessing one or more databases including records specifying payers, payees, funding sources, real accounts, and authentication information.

In various embodiments, the brokerage server includes a payment module that facilitates funding or transfer of the payment from one or more payer-selected funding sources to one or more real accounts of the payment broker and from the one or more real accounts of the payment broker to one or more real accounts of the payee to complete the payment transaction without divulging the payer-selected funding source(s) or the payer-selected real account(s) to the payee.

In various embodiments, the brokerage server includes a payment module that facilitates the funding or transfer of the payment from one or more payer-selected funding sources to one or more real accounts of the payment broker and from one or more real accounts of the payment broker to the payee by issuance, by the payment broker, of one or more instruments of remittance or transfer and (i) mailing the instruments to the payee, (ii) delivering the instruments to the payee or (iii) holding the instruments for pick-up by the payee in order to complete the payment transaction without divulging the payer-selected funding source(s) or the payer-selected real account(s) to the payee.

In a third aspect, the invention relates to a system for facilitating a payment. The system includes: (i) an electronic device running an application for authenticating or obtaining authentication information from a payer, obtaining payee-identifying information, and facilitating selection by the payer of one or more funding sources and one or more real accounts associated with the payer; (ii) a brokerage server for authenticating and identifying the payer based on the authentication information and requesting approval from the payer-selected funding source(s) to make a payment; and (iii) a funding-source server for receiving an authorization request and payment routing and clearing instructions and causing payment to be made to the payee to complete the payment transaction without divulging the payer-selected funding source(s) or the payer-selected real account(s) to the payee.

In various embodiments, the funding-source server causes the funding or transfer of the payment from one or more payer-selected funding sources to one or more real accounts of the payment broker and from one or more real accounts of the payment broker to one or more real accounts of the payee to complete the payment transaction without divulging the payer-selected funding source(s) or the payer-selected real account(s) to the payee.

In various embodiments, the funding-source server facilitates the funding or transfer of the payment from one or more payer-selected funding sources to one or more real accounts of the payment broker and from one or more real accounts of the payment broker to the payee by issuance, by the payment broker, of one or more instruments of remittance or transfer and (i) mailing the instruments to the payee, (ii) delivering the instruments to the payee or (iii) holding the instruments for pick-up by the payee in order to complete the payment transaction without divulging the payer-selected funding source(s) or the payer-selected real account(s) to the payee.

Reference throughout this specification to “one example,” “an example,” “one embodiment,” “an embodiment,” “one implementation,” or “an implementation” means that a particular feature, structure, or characteristic described in connection with the example is included in at least one example of the present invention. Thus, the occurrences of the phrases “in one example,” “in an example,” “one embodiment,” “an embodiment,” “in one implementation” or “an implementation” in various places throughout this specification are not necessarily all referring to the same example. Furthermore, the particular features, structures, routines, steps, or characteristics may be combined in any suitable manner in one or more examples of the present invention. The headings provided herein are for convenience only and are not intended to limit or interpret the scope or meaning of the claimed invention.

### BRIEF DESCRIPTION OF THE DRAWINGS

FIG. 1 depicts an architecture and operation of a payer/merchant, purchase/payment transaction;

FIG. 2 depicts a transaction flow in accordance with one embodiment of the current invention;

FIG. 3 depicts an architecture and the operation of a payer/payee payment transaction; and

FIG. 4 depicts a transaction flow in accordance with another embodiment of the current invention.

### DETAILED DESCRIPTION OF THE INVENTION

### Definitions

For purposes hereof, the following definitions apply regardless of whether a given term is expressed with or without an initial capital letter.

Payer: A payer can be any individual or legal entity wishing to make or cause a payment to be made to a payee. The payer is the person or legal entity that initiates, instructs and controls the systems and methods established and implemented by the payment broker as described in further detail herein. The payer can also designate one or more agents or users to act for and as authorized by the payer in communicating with and instructing the payment broker regarding the selection of funding source(s) and real account(s) to be used for payment(s), the initiation of the authorization process and the manner in which the payment(s) is/are routed and cleared for deposit in payee(s) real accounts or otherwise mailed, sent, delivered or held to or for payee(s). Indeed, in a given payment transaction, an individual or entity may be both the payer and the payee.

Payee: A payee can be any individual or legal entity receiving a payment, including without limitation, a merchant. The role of payer or payee is interchangeable based upon the circumstances of the underlying payment transaction, but for every payment transaction there is a payer and a payee.

Payment: Any payment, remittance or transfer of funds for any purpose whatsoever including, without limitation, for the payment of debts, bills or wages; for the purchase of goods or services or for contributions or donations; or any other transfer or conveyance of value whatsoever, including, without limitation, the provision or conveyance of goods or services; or the provision or conveyance of a credit for goods or services; a transfer or license of content, information, software or intellectual property; or any other payment, remittance or transfer of funds or value whatsoever, whether now in existence or arising in the future.

Funding Source: A funding source can be a financial institution, credit union, credit card company, phone company, lending organization or any other merchant, service provider, business, legal entity or individual that the payer has a real account with that can be used to make a given payment. This is the business, legal entity or individual that will make the payment to the payee for or on behalf of and at the direction of the payer as described herein. In the case of credit accounts, this is the business, legal entity or individual that will extend credit in order to make the payment, and assume the credit risk of the credit extension. Other examples of funding sources can include organizations such as PayPal, Apple, Charles Schwab or any business, legal entity or individual where the payer has a real account, and where the funding source's server will authorize and/or the funding source will guarantee the payment to the payee for or on behalf of and at the direction of the payer as described herein. As discussed herein, a payer may have multiple funding sources. In addition, the payment broker can itself also be a funding source if it hosts one or more real accounts for a payer.

Electronic Devices: These can be typical stationary point of sale terminals found in use today at payee (e.g., merchant) locations. These can also include portable electronic devices such as mobile phones or other devices including, without limitation, PDAs or computer tablets, or any computer, computer system, server or electronic device that is Internet-enabled or that can communicate with the payment broker using traditional or wireless telephone networks or systems, or other means of electronic or analog communication whether now in existence or arising in the future. An electronic device may also be able to communicate with other electronic devices. As discussed herein, an electronic device may also include an Internet web site or a touch-tone or rotary telephone. It is also important to note that a payer or payee can each register multiple electronic devices with the payment broker with each such device available for the payer's or payee's use, respectively, in communicating with or instructing the payment broker. In addition, each payer or payee can also register one or more electronic devices with the payment broker for use by their respective authorized agents or users in communicating with or instructing the payment broker for and on their behalf. Each of the foregoing electronic devices can be configured to communicate with the payment broker generally or can be configured with restrictions such as limits as to the authorized user(s), funding source(s), depository institution(s) or real account(s) that may be accessed to make payments or that may be designated to receive payments, etc. Further, a given electronic device can be a payer electronic device, a payee electronic device or both a payer and a payee electronic device depending upon the payment transaction involved.

Payment Broker: This is a legal entity or organization that establishes and implements the servers and methods described herein. The payment broker acts at the direction and instruction of the payer. The payment broker's servers have the ability to process payment instruction(s) from the payer and to ensure that the payee(s) will receive the requested payment(s) from whatever appropriate funding source(s) and real account(s) the payer chooses for a particular payment(s). The payment broker's servers direct the payer's funding source(s) to send the specified payment(s) from the payer's real account(s) to the payee for and on behalf of the payer and at the payer's direction or to send the payment(s) from the payer's real account(s) to a real account of the payment broker for further sending, mailing or delivery to or holding for pick-up by the payee.

Payment Broker Account Reference Numbers: These are user-controlled identifiers (numbers, names or combinations of numbers, characters or names) that the payer (or in some cases the payee) chooses to represent real accounts that they have with various funding sources or payment receiving financial institutions.

Real Account(s): A “real account” is a specific user account with an identifier known to the user and the funding source or depository institution, such as a credit card number, debit card number, checking account number, deposit account number, merchant or service provider account number, etc. Examples of real accounts are accounts as now known or as may be developed in the future including accounts that are associated with credit cards or debit cards, and including demand deposit accounts, checking accounts, loyalty accounts, value accounts, savings accounts, credit union accounts or deposit accounts, or credit accounts with merchants or service providers, etc. When the payer or payee sets up a relationship with the payment broker, they provide the identifiers corresponding to the real account(s) to be used for payments or deposits, and they can also choose their own payment broker account reference number(s) to represent the real account(s) and their identifier(s) that are known to them.

Thus, a payment broker account reference number can be used by a payer or payee as a reference and association to a given real account and related identifier at a given funding source or depository institution when transacting via the payment broker. For example, rather than entering a real account identifier in an electronic device, a payer or payee may send the payment broker their payment broker account reference number that will be used by the payment broker to associate it with the payer's or payee's corresponding real account at a specific funding source or depository institution for use in a particular payment transaction. In this manner, real account identifiers are not stored on or sent by the electronic device and are less likely to be compromised or captured by hackers or criminals.

One of the main functions of the payment broker can be to make the funding source(s), real account(s) and, in most cases, the methods of payment, selected by the payer opaque to the payee. That is, the payee may not have any visibility into, control over or concern about the funding source(s) or real account(s) selected by the payer or, in most cases, the methods by which the payment(s) is/are deposited into the payee's real account or otherwise mailed or delivered to or held for pick-up by the payee. Of course, as discussed herein, a payee may alternatively request that the payment be made by the payment broker to the payee for or on the payer's behalf by issuing a check, money order or other remittance to the payee and mailing or delivering the payment to the payee or holding it for pick-up by the payee, and the payer may, if the payer wishes, authorize and/or instruct the payment broker to use its server to accommodate the payee's request. Provided that the requested payment is authorized by the funding source's server and the payee is so notified, the payment broker can or will guarantee the payment to the payee provided that there are no abnormal circumstances relating to the payment. The approval or denial of an authorization request can be sent by the payment broker's server without the payment broker's server divulging the payer-selected funding source(s) or payer-selected real account(s) to the payee.

### Architecture and General Flow

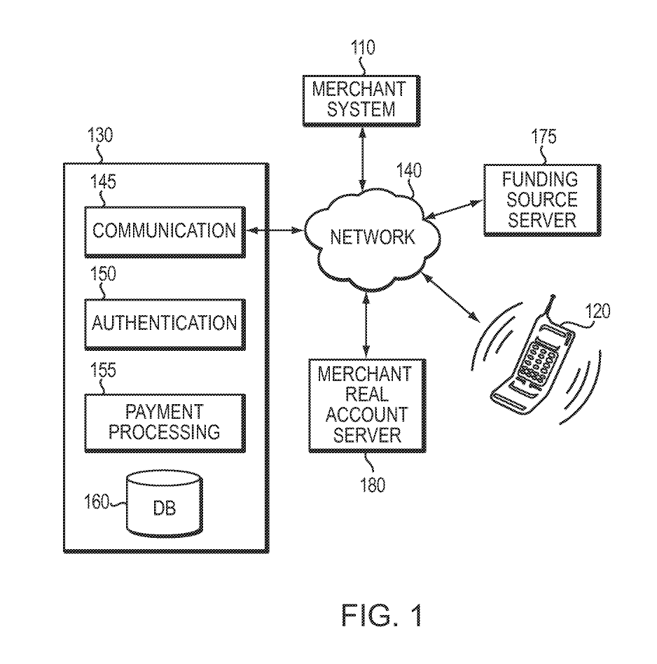

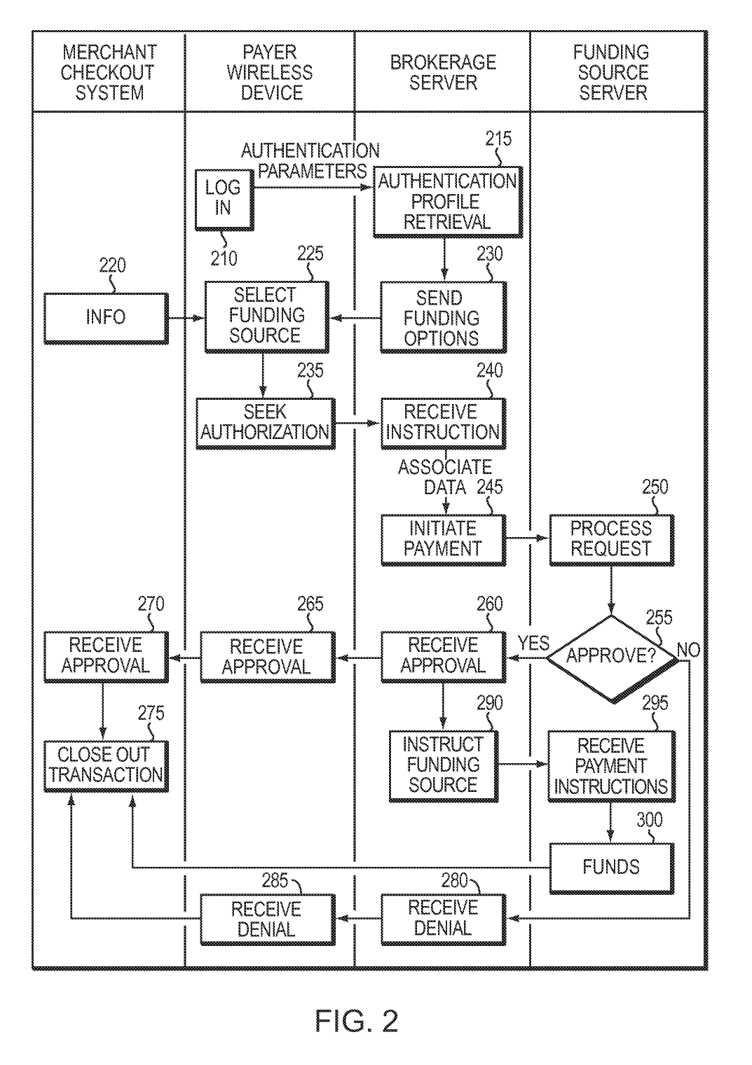

FIGS. 1 and 2 illustrate the architecture and operation of one exemplary embodiment of the invention, based on a typical purchase/payment transaction in a brick and mortar merchant location. In this example, the payee is a merchant and the payer is an individual purchaser shopping at the store.

With reference to FIG. 1, the merchant's computerized checkout system 110 may include a wireless communication facility for communicating with the payer's wireless electronic device 120, which may, for example, be a smart phone. The payer's device 120 may store and run a software application provided by the payment broker's server 130 (another electronic device) to facilitate payment transactions. In particular, the payment broker's server 130 may include a communication facility 145 permitting communication with a network 140—e.g., the Internet and/or any other land-based or wireless telecommunications network or system)—and, through network 140, with merchant system 110 and the payer's device 120. In addition, the payment broker's server 130 may contain an application 150 executing as a running process that enables the user to log in and authenticate himself or herself to the payment broker's server 130.

The payment broker's server 130 may include a payment application 155 executing as a running process and performing the brokerage tasks described herein, as well as a database 160 that may contain, for example, records for each authorized payer, payee, electronic device, software application, funding source and real account as well as related payment routing and clearing instructions, etc. These records may include, without limitation, identifying and authentication information for each payer, payee, electronic device, software application, funding source, payment broker account reference number and associated real account identifier. Based on these records and the preferences specified by a payer in a payment transaction, the payment broker's server 130 communicates, via network 140, with various servers 175 (i.e., electronic devices) operated by funding sources and hosting the payer's real accounts, and with various servers 180 (i.e., electronic devices) hosting the payee's real accounts.

The payment broker's server 130, merchant system 110, funding source server 175 and the server 180 hosting the merchant's depository real account may each include a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as, but not limited to, Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system or platform.

Any suitable programming language may be used to implement without undue experimentation the payment-processing operations described herein. Illustratively, the programming language used may include, but not be limited to, assembly language, Ada, APL, Basic, C, C++, C#, COBOL, dBase, Forth, FORTRAN, Java, Modula-2, Objective C, Pascal, Prolog, Python, RUM Smalltalk and/or JavaScript for example. Further, it is not necessary that a single type of instruction or programming language be utilized in conjunction with the operation of the systems and methods of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, network attached storage and the like. The storage media are typically connected to the system bus through a removable or non-removable memory interface.

The processing unit that executes commands and instructions may be a general purpose computer, but may also utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

In one embodiment, the payer is an individual who has a relationship with the payment broker and has designated at least one available funding source and real account/real account identifier to the payment broker. The payer has also assigned a payer-defined payment broker account reference number to correspond to the designated real account identifier. With reference to FIGS. 1 and 2, a representative transaction flow includes the following steps:
1. The payer spends some time shopping in the store. When ready, the payer presents a shopping cart or items to the merchant checkout location.
2. The payee (or in some cases the payer in self check-out situations) totals the cost of the items for purchase. The total cost and other necessary merchant data (including, but not limited to, a merchant identification or reference number stored in the payment broker's database 160, and which is associated with and identifies the particular merchant to the payment broker) are held in a typical POS terminal or other electronic device associated with merchant system 110. At this point, the payment process can begin.
3. The payer activates the payment broker software application on his or her electronic device 120, initiating step 210.
4. The payer authenticates himself or herself to the payment broker software application, which recognizes the payer. Alternatively, the payer uses the payment broker software application running on the payer's device 120 to communicate via a secure session with and authenticate himself or herself to the payment broker's server 130 (step 215). Any suitable authentication method or technology may be used, including but not restricted to, authentication via password/PIN entry and/or biometrics, digital signature functionality, or other two factor or three factor authentication all local to the electronic device, as well as additional known authentication processes at the payment broker's server to ensure that the payer, electronic device, software application and designated payee are properly authenticated so that the processing and completion of the requested payment transaction can continue.
5. The merchant system 110 communicates with the payer's device 120 and transfers the total sales data and other necessary merchant data to the payer's device 120 or in any other manner (e.g., by manual entry by the payer into the payer's device 120) (step 220).
6. The payer chooses which funding source and real account to use for the payment (step 225). The payer can make this designation by sending the payment broker's server 130 his or her corresponding payment broker account reference number from a list previously established via the payment broker software application running on device 120. Alternatively, the payment broker's server 130 can communicate via a secure session with payer's device 120 and provide one or more payment broker account reference numbers for selection by the payer (step 230). (In some embodiments, the payer may have pre-specified payment preferences.) The payment broker software application running on the payer's electronic device 120 packages the payee's transaction data with the payee identification or reference number, payer's electronic device data, payer's software application data, funding source identification, payment broker account reference number and/or other transaction data, and processes a payment instruction to the payment broker.
7. The payer's device 120 communicates the payment transmission to the payment broker's server 130 via a secure session over network 140 and sends the applicable payer, electronic device, software application, payee, funding source identification, payment broker account reference number and other transaction data and/or the payer's payment instruction to the payment broker for authentication and payment authorization (step 235). The payment broker's server 130 recognizes the payer, electronic device, software application, payee, funding source and/or payment broker account reference number and retrieves the associated records from database 160.
8. The payment broker's server 130 receives the payer's payment transmission (step 240), assigns payment transaction reference number(s) to the instruction and associates the supplied payment broker account reference number to the appropriate funding source and real account for actual real account identifier and data known to and required by the funding source's server 175. The payment broker's server 130 also associates payer and payee identification with information previously set up by the payer or payee, including funding source access preferences, funding source and real account identification, and any payment preferences and/or preferred depository real account(s) of the payee.
9. The payment broker's server 130 provides further processing (step 245) to establish that the payer's funding source will authorize the requested payment transaction for or on behalf of the payer. This may include constructing an approval request based upon funding source requirements. This may also include the payment broker's server 130 sending the approval request to the funding source's server 175 requesting authorization (steps 250, 255).
10. The funding source's server 175 receives and processes the approval request, approves the payment or declines the transaction (step 255) and sends its response to payment broker's server 130 (step 260 or 280).
11. The payment broker ensures that an authorization approval message is sent to both the payer and the payee, which in this case is a merchant. The authorization approval and transaction reference number(s) (and possibly other identifiers, approval codes, day and time identifiers, or other information or data) may be sent by the payment broker's server 130 to the payer's device 120 (step 265), which sends it to the merchant system 110 (step 270). Alternatively, the authorization approval and transaction reference number(s) (and such other identifiers, approval codes, day and time identifiers or other information or data) may be sent by the payment broker's server 130 to the merchant system 110, which sends it to the payer's device 120, or the payment broker's server 130 may send the authorization approval and transaction reference number(s) (and such other identifiers, approval codes, day and time identifiers or other information or data) simultaneously to merchant system 110 and payer's device 120. Alternatively, the payer's device 120 or the merchant system 110 may receive the authorization approval and transaction reference number(s) (and such other identifiers, approval codes, day and time identifiers or other information or data) for display to the payer or merchant, who communicates it orally to the merchant or payer, as appropriate.
12. Provided the authorization is approved, the merchant closes out the purchase transaction (step 275) and the payer leaves with his or her merchandise. The merchant concludes the transaction using the information provided by the payment broker, which includes, without limitation, transaction reference number(s) and authorization approval (and possibly other identifiers, approval codes, day and time identifiers, or other information or data needed by the payer, payee (e.g., a merchant) or payment broker for their respective processing) for an appropriate audit (i.e., static and dynamic (i.e., real-time)) and security trail. The payment broker can or will guarantee the payment to the merchant provided there are no abnormal circumstances relating to the payment.
13. If the authorization is not approved, the transaction reference number(s) and denial (and possibly other identifiers, approval codes, day and time identifiers or other information or data) may be sent by the payment broker's server 130 to the payer's device 120 (step 280) which forwards it to the merchant system 110 (step 285). Alternatively, the transaction reference number(s) and denial (and such other identifiers, approval codes, day and time identifiers or other information or data) may be sent by the payment broker's server 130 directly to the merchant system 110, which forwards it to the payer's device. The payment broker's server 130 may send the transaction reference number(s) and denial (and such other identifiers, approval codes, day and time identifiers or other information or data) to both the merchant and the payer by any other known communication means. The merchant and payer consult with each other as to the best manner to proceed in regard to the underlying purchase transaction (step 275).
14. The approval or denial of an authorization request can be sent by the payment broker's server 130 without the payment broker's service 130 divulging the payer-selected funding source(s) or payer-selected real account(s) to the payee.
15. Assuming the payment has been approved, the payment broker's server 130 instructs funding source server 175 to send the payment funds that will be used to make the payment to the payee from the payer's designated real account to a real account of the payment broker (steps 290, 295). The payment broker's server 130 also initiates, simultaneously or sequentially, another transaction that results in the deposit of those payment funds into the merchant's depository real account of record (step 300).
16. Alternatively, the payment broker's server 130 instructs the funding source's server 175 to send the payment funds from the payer's designated real account to the merchant's designated depository real account using well known merchant banking, ATM network, ISO or third party clearing systems (step 300).
17. If, after the payment has been made, the payer has a dispute with the merchant concerning the goods or services purchased, the payer can send a charge-back message to the payment broker's server 130 using payer's device 120 or through any other appropriate means to communicate with the payment broker. If and when permitted by applicable laws, regulations and rules, the payment broker will reverse the prior payment transaction and cause a debit to the merchant's designated real account (via server 180) in the amount of the prior payment and a credit to the payer's designated real account at its designated funding source (via server 175) in the same amount.
18. However, to avoid fraud, credits for returns of products by a payer to a merchant (i.e., merchant returns) are ordinarily only processed by the payment broker if and when the merchant sends a message to the payment broker that the return has occurred and the merchant instructs the payment broker to reverse the prior payment transaction. The merchant may send such a message and instruction using merchant system 110 to communicate with payment broker's server 130 or by any other means. As with charge-backs as described above, the payment broker's server 130 would cause a debit to the merchant's designated real account (via server 180) in the amount of the prior payment and a credit to the payer's designated real account at its designated funding source (via server 175) in the same amount. Thus, in merchant return situations, the merchant essentially becomes the payer and the former purchaser becomes the payee of the described systems and methods in order to effectuate the merchant return transactions.

### Other Implementations

The systems and methods described herein provide a new model for payments made from a payer to or on behalf of a payee. It will be understood that the payment systems and methods described herein are not limited to merchant/payer (e.g., purchaser) payment transactions but can be used for virtually any payment transaction where the payer wishes to direct a payment from their designated funding source(s) and real account(s) to or on behalf of any payee. Other transactions may include any transaction where there is payment from one person or legal entity to another person or legal entity (including money transfers, bill payments, utility payments, the payment of wages, contributions, donations, or any other payment or remittance of funds or transfer of value.)

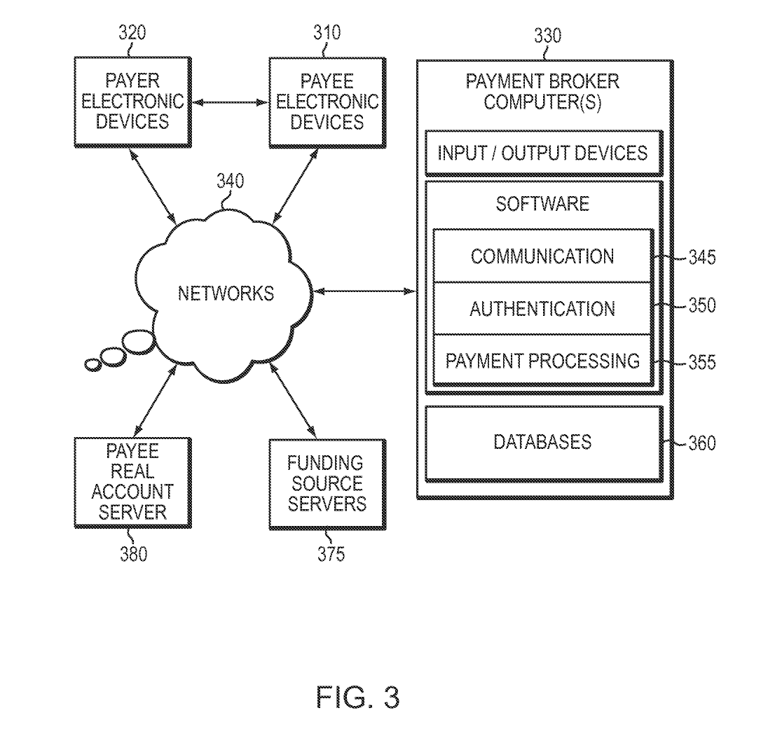

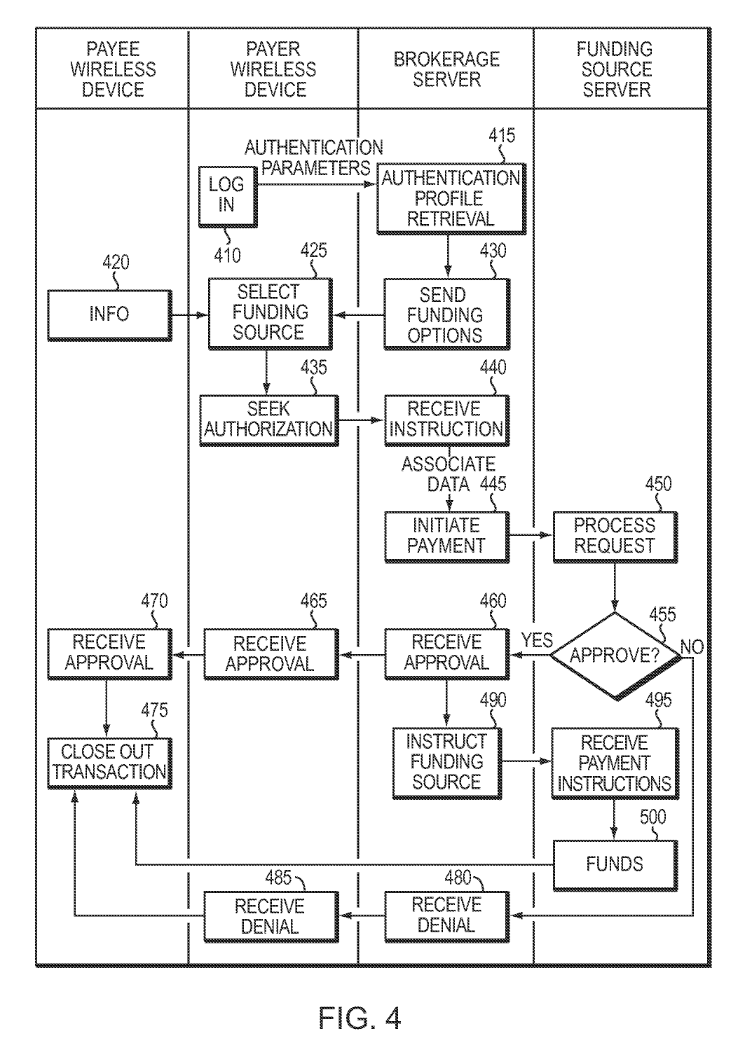

FIGS. 3 and 4 illustrate the architecture and operation of another exemplary embodiment of the invention, based on a typical payer-to-payee payment transaction. In this example, both the payee and the payer are individuals. The payment can be made for any purpose including, without limitation, for the purchase of goods or services; for the payment of debts, bills or wages; or for contributions or donations; or may cause or result in any other conveyance or transfer of value whatsoever, including, without limitation, the provision or conveyance of goods or services; the provision or conveyance of a credit for goods or services; a transfer or license of content, information, software or intellectual property; or any other payment, remittance or transfer of funds or value whatsoever, whether now in existence or arising in the future.

With reference to FIG. 3, the payee's wireless electronic device 310 may include a wireless communication facility for communicating with the payer's wireless electronic device 320, which may, for example, be a smart phone. The payer's device 320 may store and run a software application provided by the payment broker's server 330 (another electronic device) to facilitate payment transactions. In particular, the payment broker's server 330 may include a communication facility 345 permitting communication with a network 340—e.g., the Internet and/or any other land-based or wireless telecommunications network or system)—and, through network 340, with payee's device 310 and the payer's device 320. In addition, the payment broker's server 330 may contain an application 350 executing as a running process that enables the user to log in and authenticate himself or herself to the payment broker's server 330.

The payment broker's server 330 may include a payment application 355 executing as a running process and performing the brokerage tasks described herein, as well as a database 360 that may contain, for example, records for each authorized payer, payee, electronic device, software application, funding source and real account as well as related payment routing and clearing instructions, etc. These records may include, without limitation, identifying and authentication information for each payer, payee, electronic device, software application, funding source, payment broker account reference number and associated real account identifier. Based on these records and the preferences specified by a payer in a payment transaction, the payment broker's server 330 communicates, via network 340, with various servers 375 (i.e., electronic devices) operated by funding sources and hosting the payer's real account(s), and with various servers 380 (i.e., electronic devices) hosting the payee's real accounts.

The payment broker's server 330, funding source server 375 and server 380 hosting the payee's depository real account may each include a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may include computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as, but not limited to, Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system or platform.

Any suitable programming language may be used to implement without undue experimentation the payment-processing operations described herein. Illustratively, the programming language used may include, but not be limited to, assembly language, Ada, APL, Basic, C, C++, C#, COBOL, dBase, Forth, FORTRAN, Java, Modula-2, Objective C, Pascal, Prolog, Python, RUM Smalltalk and/or JavaScript for example. Further, it is not necessary that a single type of instruction or programming language be utilized in conjunction with the operation of the systems and methods of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, network attached storage and the like. The storage media are typically connected to the system bus through a removable or non-removable memory interface.

The processing unit that executes commands and instructions may be a general purpose computer, but may also utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

With reference to FIGS. 3 and 4, the payer is an individual who has a relationship with the payment broker and has designated at least one available funding source and real account/real account identifier to the payment broker. The payer has also assigned a payer-defined payment broker account reference number to correspond to the designated real account identifier. In one embodiment, a representative transaction includes the steps of:
1. The payer wishes to make a payment to a payee who is also an individual.
2. The necessary payee data (including, but not limited to, a payee identification or reference number stored in the payment broker's database 360, and which is associated with and identifies the particular payee to the payment broker) are held in the payee's electronic device 310 or otherwise provided to the payer. At this point, the payment process can begin.
3. The payer activates the payment broker software application on his or her electronic device 320, initiating step 410.
4. The payer authenticates himself or herself to the payment broker software application, which recognizes the payer. Alternatively, the payer uses the payment broker software application running on the payer's device 320 to communicate via a secure session with and authenticate himself or herself to the payment broker's server 330 (step 415). Any suitable authentication method or technology may be used, including but not restricted to, authentication via password/PIN entry and/or biometrics, digital signature functionality, or other two factor or three factor authentication all local to the electronic device, as well as additional known authentication processes at the payment broker's server to ensure that the payer, electronic device, software application and designated payee are properly authenticated so that the processing and completion of the requested payment transaction can continue.
5. The payee's electronic device 310 communicates with the payer's device 320 and transfers the necessary payee identification information to the payer's device 320 or in any other manner (e.g. by manual entry by the payer into the payer's device 320) (step 420).
6. The payer chooses which funding source and real account to use for the payment (step 425). The payer can make this designation by sending the payment broker's server 330 his or her corresponding payment broker account reference number from a list previously established via the payment broker software application running on device 320. Alternatively, payment broker's server 330 can communicate via a secure session with payer's device 320 and provide one or more payment broker account reference numbers for selection by the payer (step 430). (In some embodiments, the payer may have pre-specified some payment preferences.) The payment broker software application running on the payer's electronic device 320 packages the payee's transaction data with the payee identification or reference number, payer's electronic device data, payer's software application data, funding source identification, payment broker account reference number and/or other transaction data, and processes a payment instruction to the payment broker.
7. The payer's device 320 communicates the payment transmission to the payment broker's server 330 via a secure session over network 340 and sends the applicable payer, electronic device, software application, payee, funding source identification, payment broker account reference number and/or other transaction data and the payer's payment instruction to the payment broker for authentication and payment authorization (step 435). The payment broker's server 330 recognizes the payer, electronic device, software application, payee, funding source and/or payment broker account reference number and retrieves the associated records from database 360.
8. The payment broker's server 330 receives the payer's payment transmission (step 440), assigns a payment transaction reference number to the instruction and associates the supplied payment broker account reference number to the appropriate funding source and real account for actual real account identifier and data known to and required by the funding source's server 375. The payment broker's server 330 also associates payer and payee identification with information previously set up by the payer or payee, including funding source access preferences, funding source and real account identification, and any payment preferences and/or preferred depository real account(s) of the payee.
9. The payment broker's server 330 provides further processing (step 445) to establish that the payer's funding source will authorize the requested payment for or on behalf of the payer. This may include constructing an approval request based upon funding source requirements. This may also include payment broker's server 330 sending a message to the funding source's server 375 requesting authorization (steps 450, 455).
10. The funding resource's server 375 receives and processes the approval request, approves the payment or declines the transaction (step 455) and sends its response to the payment broker's server 330 (step 460 or 480).
11. The payment broker ensures that an authorization approval message is sent to both the payer and the payee. The authorization approval and transaction reference number(s) (and possibly other identifiers, approval codes, day and time identifiers, or other information or data) may be sent by the payment broker's server 330 to the payer's device 320 (step 465), which sends it to the payee's device 310 (step 470). Alternatively, the authorization approval and transaction reference number(s) (and such other identifiers, approval codes, day and time identifiers or other information or data) may be sent by the payment broker's server 330 to the payee's device 310, which sends it to the payer's device 320, or the payment broker's server 330 may send the authorization approval and transaction reference number(s) (and such other identifiers, approval codes, day and time identifiers or other information or data) simultaneously to the payee's device 310 and payer's device 320. Alternatively, the payer's device 320 or the payee's device 310 may receive the authorization approval and transaction reference number(s) (and such other identifiers, approval codes, day and time identifiers or other information or data) for display to the payer or payee, who communicates it orally to the payee or payer, as appropriate.
12. Using the information provided by the payment broker, which includes, without limitation, transaction reference number(s) (and possibly other identifiers, approval codes, day and time identifiers, or other information or data needed by the payee for its processing) for an appropriate audit (i.e., static and dynamic (i.e., real-time)) and security trail, the payee concludes whatever transaction or matter the subject payment was intended for. The payment broker can or will guarantee the payment to the payee provided there are no abnormal circumstances relating to the payment.
13. If the authorization is not approved, the transaction reference number(s) and denial (and possibly other identifiers, approval codes, day and time identifiers or other information or data) may be sent by the payment broker's server 330 to the payer's device 320 (step 485) which forwards it to the payee's device 310 (step 475). Alternatively, transaction reference number(s) and denial (and such other identifiers, approval codes, day and time identifiers or other information or data) may be sent by the payment broker's server 330 directly to the payee's device 310, which forwards it to the payer's device or the payment broker's server 330 may send the transaction reference number(s) and denial (and such other identifiers, approval codes, day and time identifiers or other information or data) to both the payee and the payer by any other known communication means. The payee and payer consult with each other as to the best manner to proceed in regard to the transaction or matter the payment was intended for (step 475).
14. The approval or denial of an authorization request can be sent by the payment broker's server 330 without the payment broker's server 330 divulging the payer-selected funding source(s) or payer-selected real account(s) to the payee.
15. Assuming the payment has been approved, the payment broker's server 330 instructs funding source's server 375 to send the payment to the payee from the payer's designated real account to a real account of the payment broker (steps 490, 495). The payment broker's server 330 also initiates another transaction, simultaneously or sequentially, that will result in the deposit of the payment into the payee's depository real account of record (step 500).
16. Alternatively, the payment broker's server 330 instructs the funding source's server 375 to send the payment from the payer's designated real account to the payee's designated depository real account using well known merchant banking, ATM network, ISO or third party clearing systems (step 500).
17. If, after the payment has been made, the payer has a dispute with the payee concerning the underlying transaction or matter, the payer can send a charge-back message to the payment broker's server 330 using payer's device 320 or through any other appropriate means to communicate with the payment broker. If and when permitted by applicable laws, regulations and rules, the payment broker will reverse the prior payment transaction and cause a debit to the payee's designated real account (via server 380) in the amount of the prior payment and a credit to the payer's designated real account at its designated funding source (via server 375) in the same amount.

### Additional Functions, Features and Characteristics

In addition to the representative transaction flow described above with regard to a payee that may be a merchant, in another embodiment the payer shops at a merchant internet web site or other electronic storeroom where payers can purchase goods or services from the merchant. Thus, a point of sale can mean either a physical storefront (a “brick and mortar”) or an internet web site where payers can shop and where there is an electronic device (such as a POS terminal, cash register, personal computer, etc) or a internet web site and associated server that can communicate via wireless or wired networks or other communication means whether now known or developed in the future with other electronic devices such as personal computers or handheld electronic devices such as iPads, iPods or mobile phones.

In one implementation, the merchant's electronic device is capable of sending data to and receiving data from the payer's handheld or portable electronic device. In another implementation, the appropriate payee information is manually entered into the payer's electronic device which can be as low-tech as a conventional touch-tone or rotary telephone in communication with the payment broker. Alternatively, the payer may call or visit and speak with a customer-service representative at the payment broker and orally communicate and receive the needed information necessary to process and complete the requested payment, with the customer-service representative entering the needed information into the payment broker's server through conventional means.

Likewise, a payee can also access and use the systems and methods described herein by similarly calling, visiting and speaking with a customer-service representative of the payment broker. As described above, any means by which the payer or payee can communicate with the payment broker can be used to gather and relay the necessary information by and between the payment broker and the payer and/or payee in order to process and complete the requested payment.

In one embodiment, the payer's electronic device can send data to and receive data from the payee's electronic device (such as a POS terminal, cash register or mobile phone.) The payer's electronic device runs a software application provided by the payment broker that can contain pre-configured information about the payer and the payer's payment preferences (including designated funding source(s) and payment broker account reference number(s)) as well as the ability to package sales ticket or other payee or payer information, initiate a payment instruction, and send or respond to data required to complete the instructed payment. In some implementations, a payment broker account reference number represents both a payer-designated funding source and payer-selected real account(s) therein.

The payer's designated funding source(s) and real account(s) and, in most cases, the method of payment can be opaque to the payee since the payee will not know them, have any visibility or control over them or any concerns about them. The payee receives the payment regardless of whether the payer chooses a credit card account, debit card account, checking account, savings account, loyalty account, value account, etc. or any other funding source and real account capable of making the desired payment, and regardless of how the payment is routed and cleared to the payee's real account or otherwise mailed or delivered to or held for pick-up by the payee.

The payer may activate the payment broker provided software application on their electronic device. In one implementation, the activation represents to the payee that the payer's electronic device is ready for the transaction and prepares the software application on the payer's device to receive sales and necessary payee information from the payee's electronic device including, but not limited to, a POS terminal or cash register in the case of a payee that is a merchant. In this implementation, the merchant selects an option on its electronic device that causes the sales data, necessary merchant identification or reference number information and other data to be sent to the payer's electronic device. Once this merchant data and information is captured by the payer's electronic device, it is packaged with the payer's transaction data and related information as well as the payer's payment instruction for transmission to the payment broker's server. The resulting payment transmission is then sent to the payment broker's server for further processing and routing to the server of the payer's designated funding source(s). In some implementations, the payment broker furnishes the payee (including a merchant) with a suitable software application to be run on the payee's electronic device that facilitates this payee to payer data and information transmission.

Accordingly, in this implementation, the merchant's electronic device transmits the sales and merchant data to the payer's electronic device using some standard communication interface/protocol preferred by the industry. For example, these may be Bluetooth, RFID, Near Field Communications (NFC) and others that the industry adopts as standard communication interfaces/protocols and that are available for both the payee's and payer's electronic devices. For present purposes, the term NFC is used generally to represent any of the acceptable standard interface/communication protocols that currently exist or that may exist in the future. However, in this implementation, the only requirement is that both the payee's and the payer's electronic devices implement a compatible interface/protocol and can communicate with each other using that standard.

The payee's electronic device may contain payee transaction data that includes, without limitation, an amount, payee identification number, payee transaction reference number, date and time stamp, payee electronic device data, payee software application data, payee authentication data, and/or any other payee data required by the payment broker's server to authenticate the payee, and/or the payee's electronic device and/or software application. Once the payee's electronic device transmits the required sales, payee identification and other payee-related data and information, the payer's electronic device signals good receipt back to the payee's electronic device.

The payer's electronic device may contain the payer transaction data that includes, without limitation, payer identification data, a payer transaction reference number, date and time stamp, funding source(s) and real account(s) selected for the payment, payer electronic device data, payer software application data, and any other payer data required by the payment broker's server to authenticate the payer and/or the payer's electronic device and/or software application and process the subject payment transaction.

The payment broker software application running on the payer's electronic device readies the payment transaction for transmission to the payment broker's server for further processing and routing to the server of the payer's designated funding source(s). The payer can select a single funding source or multiple funding sources and one or more real accounts for the desired payment (i.e., may instruct the payment broker's server to implement a split payment) or the payer may instruct the payment broker's server to direct payments from certain preferred funding source(s) and real account(s) generally or only with respect to specific payees (e.g., certain merchants or types or categories of merchants.)

The payer sends the payment transmission to the payment broker's server. The common security/encryption protocols found on most mobile phones and other handheld devices such as 3G, 4G, Wireless, etc. can be used to establish a secure session with the payment broker's server.

In another implementation, the payee's electronic device communicates via a secure session and sends the payee transaction related data to the payment broker's server. The payment broker's server communicates via a secure session and sends a message to the payer's electronic device requesting the payer's electronic device to send the payer's transaction related data and payment instruction to the payment broker's server. The software application on the payer's electronic device responds by sending the payer's transaction related data and payment instruction. The payment broker's server processes the payee's transaction related data and the payer's transaction related data and payment instruction and sends an authorization request and/or payment routing and clearing instructions to the server of the payer's designated funding source(s). Alternatively, the payer's electronic device communicates via a secure session and sends the payer's transaction related data and payment instruction to the payment broker's server. The payment broker's server communicates via a secure session and sends a message to the payee's electronic device requesting the payee's device to send the payee's transaction related data to the payment broker's server. The software application on the payee's electronic device responds by sending the payee's transaction related data. The payment broker's server processes the payee's transaction related data and payer's transaction related data and payment instruction and sends an authorization request and/or payment routing and clearing instructions to the server of the payer's designated funding source(s).

In one implementation, the payment broker's server obtains from one or more secure databases of or controlled by the payment broker the real account information and method of payment to be used by the payer's designated funding source and send that information to the funding source's server. In another implementation, the payment broker's server can access the relevant database(s) of the payer's designated funding source(s) in order to obtain some or all of the necessary information and data that it needs in order to process and direct the requested payment transaction on behalf of the payer. The authorization request and/or payment routing and clearing instructions are then routed to the server(s) of the funding source(s) that may make the payment on behalf of the payer.

For example, if the payer wants to pay with funds from his bank checking account, the payment broker's server communicates with the applicable funding source's server to ascertain if the payment can be made by using existing methods known in the industry to perform a check with the funding source's server. If the funds are available, approval will be sent back to the payment broker's server. The payment broker's server then transmits the approval to the payment broker software application running on the payer's electronic device or otherwise communicates the information to the payer and/or payee as described herein. The approval or denial of an authorization request can be sent by the payment broker's server without the payment broker's server divulging the payer-selected funding source(s) or payer-selected real account(s) to the payee.

The functions performed by the payment broker's server and secure database(s) may be combined into a single server with or without a separate database or databases. In addition, if the payment broker is also acting as a funding source and hosting one or more real accounts of the payer, then for a given payment, the functions performed by the payment broker's server and the funding source's server may be combined into a single server implementation with or without a separate server for the funding source function.

The payer's mobile phone (i.e., hand held electronic device) informs the merchant's electronic device that the transaction will be honored and the merchant can release the goods to the payer. The payment broker can or will guarantee the payment to the merchant provided there are no abnormal circumstances relating to the payment. The payee may possess an electronic device capable of processing the sales information and can (preferably) communicate with the payer's electronic device using a compatible interface/protocol. In one implementation, this electronic device does not require further communication capability. The payer possesses an electronic device that is (preferably) capable of communicating with the payee's electronic device. The payer's electronic device also communicates with and sends the necessary data and payment instructions to the payment broker's server, which, in turn, processes and sends the authorization request and/or payment routing and clearing instructions to the designated funding source's server. If the authorization request is approved, the payment broker's server instructs the funding source's server to make the requested payment to the payee on the payer's behalf.

The payee can also have a typical merchant relationship with the payment broker as found in the credit card industry today; it is not, however, a requirement that the payee have a credit card relationship with the payment broker. Typical merchants or businesses that accept credit cards for payment have relationships with merchant banks or ISOs for payment authorization and/or clearing functions. In some embodiments, the payment broker or its affiliate may also be a merchant processor for typical credit and debit card transactions and a merchant may have a merchant relationship with the payment broker or its affiliate totally distinct from its relationship with the payment broker in regard to the payment systems and methods described herein.

The merchant can submit normal credit card authorization requests through the typical gateways found today (e.g., for MasterCard and Visa). However, if the payer, who also has a relationship with the payment broker, indicates that the payer would prefer to use the payer's electronic device to direct the payment to the payee using the payment systems and methods described herein, then those payment systems and methods can be invoked and used. The payer chooses which funding source(s) and real account(s) to use, then in one implementation the merchant data is captured by the payer's electronic device. The necessary data and payment instruction is then packaged and routed through whatever electronic or communication networks are available for the payer and the payment transmission may be sent to the payment broker's server for processing as described herein.

In another implementation, the payer chooses the funding source(s) and real account(s) they would like to use from their electronic device, captures the merchant's (or other payee's) data and initiates and routes the packaged transaction and related data with the payer's payment instruction through whatever electronic or communication networks are provided for the merchant (or payee) with the transaction being sent in this manner to the payment broker's server for processing as described herein. In some implementations, the payment broker's server furnishes the merchant (or other payee) with a suitable software application that facilitates the payer's use of the merchant's (or payee's) network transmission option. Thus, virtually any suitable electronic or communications network or facility may be utilized by the payer's electronic device to communicate with the payment broker's server.

A given individual or entity may be a payer in one payment transaction and a payee in another payment transaction. Indeed, a given individual or entity may be both the payer and the payee in a given payment transaction such as when a payer instructs the payment broker to make a payment from one or more of the payer's funding sources and real accounts to another real account of the payer at a depository institution. However, for each payment transaction there is always a payer and a payee, which payee may or may not be a merchant. Accordingly, the payment broker software application that runs on an electronic device may in some implementations include a payer mode of operation and a payee mode of operation, either of which modes of operation may be selected by the user or by the payment broker depending upon the circumstances. Alternatively, the user or the payment broker could also designate only a single mode of operation for a given instance of the software application on a given electronic device. Whichever mode of operation is selected, the payment broker software application performs the tasks identified herein for the mode of operation that it is then performing.

When operating in a payee mode of operation, the payment broker software application may facilitate communications between the payee's electronic device and the payer's electronic device, between the payee's electronic device and the payment broker's server, and possibly also between the payer's electronic device and the payment broker' server through a network or other communications system available to the payee. Further, when operating in a payee mode of operation, the payment broker software application may (in some implementations) package payee information, payer information and the payer's payment instruction and transmit the package to the payment broker's server on behalf of the payer via a network or other communications system available to the payee. For security purposes, the payer's information and the payer's payment instruction can be transmitted to the payee in encrypted or other secure form for packaging with the payee's information for further transmission by the payee to the payment broker's server on the payer's behalf. Of course, the payee's information can also be encrypted or otherwise made secure to reduce similar security concerns.

However, when operating in a payee mode of operation, the payment broker software application may not undertake the payer-initiated or payer-controlled operations described above that are typically implemented via the payer's electronic device or by the payment broker's server such as enabling the payer to select among available funding sources and payment broker account reference numbers associated with the payer's funding sources and real accounts, processing and formatting the payer's payment instruction to the payment broker's server or, in the case of the payment broker's server, processing and sending an authorization request and/or payment routing and clearing instructions to a funding source's server, etc. Those payer-initiated or payer-controlled operations are facilitated by the payment broker software application when operating in a payer mode of operation or by the payment broker's server when acting for or on behalf of the payer and at the payer's direction.

Further, in order to reduce the risk of fraud, theft or misappropriation, it may in certain circumstances be appropriate for the payment broker's server to authenticate the payer's electronic device and/or the payee's electronic device and/or given instances of the payment broker software application operating in a payer and/or payee mode. The payment broker's server can further assure that a payment transmission purportedly sent from a payer to the payment broker's server is in fact genuine and originates from the payer that it purports to be from, regardless of whether transmitted through a payee-accessible network or communications system via an instance of the payment broker software operating in a payee mode. In addition, it should be noted that the payment broker software application can be sold, licensed or otherwise provided to the payer or the payee by the payment broker directly, via electronic or wireless transmission or by other conventional delivery systems, or via other authorized third party delivery or transmission systems such as the Apple Store or Google Apps, etc.

The payee relationship with the payment broker can be very minimal and can, for example, consist of the payee simply providing the payment broker with payee identification information and preferably real account information for a real account into which a payment can be deposited, or an address or location where the payment can be mailed or delivered to or held for pick-up by the payee. Indeed, in some embodiments the payee may have no formal relationship with the payment broker with the payer providing the necessary payee identification information and preferably real account information for a real account of the payee into which a payment can be deposited or an address or location where the payment can be mailed or delivered to or held for pick-up by the payee. Further, the payee may not be required to have a real account of record with the payment broker as the payment broker can alternatively, upon the payer's (or in some cases the payee's) request, issue a check, money order or other form of traditional remittance or delivery of the payment. Essentially embodiments of the present invention can send the payer's payment to whoever or whatever the payer directs (including to the payer when the payer is also the payee that receives the payment), as long as the payment broker has been provided with payee identification information and preferably a real account into which the payment can be deposited or an address or location to which the payment can otherwise be mailed or delivered to or held for pick-up by the payee.

Further, the payee relationship with the payment broker may be more extensive, depending upon the payee and/or types of underlying transactions the systems and methods described herein are intended to support and that accordingly, the payer can authorize and/or instruct the payment broker to use its server to accommodate the more extensive payee relationship. Thus, most payees (including merchants) may have a much more extensive relationship with the payment broker as the systems and methods described herein are configured to support the underlying purchase, money transfer, bill payment, utilities payment, wages payment or any other payment, remittance or transfer transactions, etc. that the payer and payee wish to undertake and effect, and will likely be subject to a variety of applicable laws, regulations and rules, audit requirements (both static and dynamic (e.g., real-time)) and funding source and third party clearing system rules and requirements that are complied with in connection therewith. In one embodiment, the systems and methods described herein are configured so that the payment broker's server supports the static and dynamic (e.g., real-time) audit requirements of large merchants pertaining to the underlying purchase and payment transactions undertaken. In another embodiment, a payee (e.g., a merchant) designates to the payment broker a specific real account of the payee to be accessed by the payment broker for charge back or merchant return situations, which real account is different from the payee's real account where payments are to be deposited or made, and the payer could authorize and/or instruct the payment broker to use its server to accommodate this payee designated arrangement. As previously mentioned, in a merchant return situation, the merchant essentially becomes the payer and the former purchaser becomes the payee of the described systems and methods in order to effectuate the merchant return transaction.

In addition, the payer's relationship with the payment broker may be more or less extensive. As described above and in addition to the more typical relationship of a payer and the payment broker as described herein, a payer may register multiple electronic devices with the payment broker with each such device available for the payer's use in communicating with or instructing the payment broker. In addition, a payer may also register multiple agents or users, each authorized by the payer to communicate with and instruct the payment broker for or on the payer's behalf in order to cause payments to be made to payees from one or more funding sources and real accounts of the payer. For example, a payer may authorize her accountant to act as her agent to communicate with and instruct the payment broker for or on the payer's behalf in order to cause payment(s) to be made to payee(s) from one or more funding source(s) and real account(s) of the payer. As another example, an elderly person may authorize her son or daughter to communicate with and instruct the payment broker on the elderly person's behalf to cause payment(s) to be made from the elderly person's funding source(s) and real account(s) to payee(s). As a further example, a payer could hire an auto-pay type computer-implemented service company in order to use that company's server to automatically communicate with and instruct the payment broker on the payer's behalf to cause payment(s) to be made from the payer's funding source(s) and real account(s) to payee(s) in order for the payer to pay various periodic or non-periodic bills or debts of the payer. Further, each of the payer's authorized agents or users may also be registered with the payment broker to use one or more electronic devices that are also registered with the payment broker for such purposes. Still further, the payer may instruct the payment broker to place limits or restrictions on the payer's authorized agents or users permitted communications and payment instructions to the payment broker, such as per-payment amount limits or restrictions limiting the authorized agent or user to only being able to communicate with and instruct the payment broker to send payments only from a payer designated funding source and real account to only certain payer designated payees, etc.

As discussed previously in regard to purchaser charge backs and merchant returns in merchant/purchaser payment transactions supported by the systems and methods described herein, similar functionality and methods can be used to support other underlying payment transactions that the payer and payee may also wish to implement such as money transfers, bill payments, utilities payments, the payment of wages or any other forms of payment or remittance of funds or transfers of value, and also depending in part upon the laws, regulations and rules applicable to the subject underlying transaction(s) involved. With regard to the systems and methods described herein, the payer (and in most cases, the payee) have relationships with the payment broker that are consistent and comply with all applicable laws, regulations and rules. This applies to merchant/purchaser and other payment transactions where the payer and payee need to have relationships with the payment broker that (i) are consistent with the laws, regulations and rules governing the implemented payment transaction(s), such as charge-backs and merchant returns in merchant/purchaser transactions or applicable requirements in money transfer transactions, and (ii) authorize the payment broker to reverse prior payment transactions as described herein in a manner that is consistent with those laws, regulations and rules.

It will be seen that implementations of the systems and methods described herein may not require that the payer or payee have a electronic device to communicate with the payment broker. Any means whether now known or developed in the future by which the payer or payee can communicate with the payment broker will suffice, including by using text messaging or any analog or digital electronic device and related telecommunications network or system, a touch-tone or rotary telephone and the conventional telephone system or by visiting or speaking with a customer-service representative of the payment broker who gathers the necessary information and inputs it into the payment broker's server and orally communicates back the necessary payment transaction information to the payer and/or payee.

Authorization requests and payment instructions may be initiated and directed solely by the payer and the payer can use the payment broker's server to seek authorizations from and direct a multitude of different types of funding sources and real accounts. The payment broker's server can act solely at the payer's direction in obtaining authorization from the server of the payer's designated funding source and instructing the funding source server to send the payer's payment from the payer's real account(s) to the payee, or to send the payer's payment from the payer's real account to the payment broker for further sending, mailing or delivery to or holding for pick up by the payee. Thus, implementations of the systems and methods in accordance herewith can be “payer-controlled” and can support virtually all payment transaction types (e.g., credit card, debit card, checking account, deposit account, loyalty account, value account, etc.) and all payment purposes (point of sale purchases, money transfers, bill payment, payment of wages, utility payments, donations, contributions or any other payments or remittances of funds or transfers of value, etc.) As previously indicated, the payer may designate one or more agents or users to act for and as authorized by the payer in communicating with and instructing the payment broker's server in order to cause payment(s) to be made to payee(s). The payer may select a single funding source or multiple funding sources and a single real account or multiple real accounts for the desired payment (i.e., may direct the payment broker's server to implement a split payment) or the payer may instruct the payment broker's server to direct payments from certain preferred funding source(s) or real account(s) generally or only with respect to specific payees.

Implementations of the systems and methods described herein can also eliminate much of the risk for the payee. In addition, since the payer initiates and controls the authorization and payment transaction, the risk of fraud from a third party accessing the payer's real account(s) is much reduced, particularly since real account identifying information is not stored, transmitted or received by the payer's or payee's electronic devices. In one implementation, the payment broker's server calls on one or more secure databases for information relating to the payer or payee and processing options. The database information may be stored in the payment broker's secure site or elsewhere, or it may be stored in one or more databases at one or more funding sources, but the payment broker's server ensures that appropriate information necessary to obtain authorization for the instructed payment transaction is available along with payment routing and clearing instructions to compete the requested payment. In addition, if the payment broker is also acting as a funding source and hosting one or more real accounts of the payer, then for a given payment, the functions performed by the payment broker's server and the funding source's server may be combined into a single server implementation with or without a separate server for the funding source function.

In some embodiments, the payment broker's server has completed the required processing, gained authorization approval from the funding source's server, etc. and instructed the sending of the payment to the payee, and would then provide completion information for routing back to the payer and/or payee. In one embodiment, the authorization and payment can occur in real-time since once authorization has been obtained from the funding source's server, the payment can be made pursuant to the payer's instructions. The funding source's server is then provided with concurrent instructions to the effect that if authorization is approved, payment is to be made to the payee (e.g., if-then type instructions.).

In other embodiments, such as those involving a typical credit or debit card authorization request, the payment broker's server calls upon one or more secure database(s) owned or controlled by the payment broker or funding source to obtain all necessary data and information and continue with an authorization request to the funding source's server (e.g., a credit issuing institution); gains authorization approval from the funding source's server; and then transmits the authorization approval to the payer's and/or payee's electronic device with the related instruction to the funding source's server to make the payment on a periodic or batch settlement basis.

The approval or denial of the authorization request can be sent by the payment broker's server without the payment broker's server divulging the payer-selected funding source(s) or payer-selected real account(s) to the payee.

Since typically there is very little information (for security and privacy concerns) stored on the payer's or payee's electronic device, the payment broker's server calls on the applicable secure database(s) to supply necessary data and information in order to complete most payment transactions. It is preferred that no funding source, real account or related identifier data be stored on any payer or payee electronic device that is part of an implementation in accordance herewith. In one implementation, the payer's electronic device software application does not permanently store any payment transaction data on the device but only sends such data to the payment broker's server for processing.

The systems and methods described herein may or may not use existing Visa, MasterCard, Discover, American Express, or other conventional credit or debit networks typically used at a payee (e.g., a merchant) location for authorization, clearing and settlement purposes. If the payer elects to pay with a credit or debit card real account designated to the payment broker's server at a given funding source, the payment broker's server may route the authorization request to the appropriate card network that will route the request to the server of the issuing funding source to process and respond to the authorization request and/or related payment routing and clearing instructions. If the payer elects to pay using a transfer of funds from a debit card real account at a funding source to the payee's designated real account at a deposit accepting financial institution, then other known existing networks may be used to complete the payment transaction.

When the funding source's server sends a payment from the payer's real account to the payee as directed by the payment broker's server on the payer's behalf and at the payer's direction, the payment can be sent in any manner now known or developed in the future that will result in the payment being deposited into the payee's designated real account of record or otherwise mailed or delivered to or held for pick-up by the payee. These methods may include, without limitation, depositing the payment directly into the payee's real account (if that account is also at the funding source) or sending the payment to a merchant bank clearing system, an ATM network, to an ISO, to any other third party clearing system or to an account of the payment broker to be sent by the payment broker's server to the payee directly, via any merchant bank clearing system, ATM network, ISO or third party clearing system or by the payment broker's issuance of a check, money order or other remittance or payment of funds or transfer of value to the payee as necessary to result in the payment being deposited in the payee's designated real account of record or otherwise mailed or delivered to or held for pick-up by the payee. However, in a preferred embodiment the manner in which authorization is obtained from a given funding source's server or a payment is routed, cleared and sent to a payee will be determined by the payment broker's server such that the manner in which authorization is obtained and/or the funding source's server is instructed to route and clear the payment will each be determined with a view to reducing or eliminating unnecessary fees or charges that might otherwise be incurred at the funding source or in connection with alternative methods of routing and clearing or delivering the payment.

Any type of telecommunications system by which the payment broker's server can communicate with a funding source's server (and vice versa) in order to route authorization requests or payment routing and clearing instructions or to receive authorization approvals, denials or confirmations of remittance or transfer, or to transmit or receive any other instructions, confirmations or completion information appropriate to the operation of the systems and methods described herein can be used in connection with the described systems and methods including, without limitation, the internet, dedicated telecommunications lines, satellite telecommunications systems or third party wireless or land based telecommunication networks or clearing systems, etc. Further, as directed by the payment broker's server for or on behalf of the payer, the funding source's server could also use such telecommunications systems to communicate with the payer and/or payee in order to communicate authorization approvals, denials or completion confirmations of payments, remittances or transfers, etc. It will also be seen that the systems and methods described herein can be used globally wherever the necessary telecommunications, network and payment clearing infrastructures are available.

In a preferred embodiment of the systems and methods described herein, the payment broker's server, as well as the payer's electronic device and related payment broker software application operating in a payer mode of operation or the payee's electronic device as well as the related payment broker software application operating in a payee mode of operation can each be configured and implemented to incorporate and use state of the art user validation, privacy and compliance functionality such as multi-factor authentication, strong cryptography, geolocation, PKI, encrypted database(s), digital ink and digital signature functionality, as well as dynamic (e.g., real-time) audit functionality for fraud or irregularity detection, and instant application locking if fraud or an irregularity is detected or other validation, authentication, privacy, compliance, fraud or irregularity detection technologies that may be developed in the future.

Indeed, in one preferred implementation, the payment broker's server is organized and configured to provide the functionality and implement the methods described herein via a single backend push-pull engine and database(s) configuration structure. Such a configuration can allow the addition of new functionality and features on-the-fly. In addition, any payer entitlements or benefits (such as coupons, special offers or other add-value features, etc.) that may be offered to a payer by the payment broker or its alliance members or commercial partners (including possibly merchants or funding sources) can be managed dynamically and driven by a master payer profile, thereby facilitating the addition of new entitlements or benefits on-the-fly with all related data and content pulled and processed by the payment broker's server on the payer's behalf in real-time. This configuration or other configurations that may be developed in the future can allow for single-point testing, certification and upgrading as well as flexibility in adding new functionality, features, entitlements and benefits. Further, alliance or commercial partner entitlements, benefits and data can be added or removed conveniently via direct feeds, the use of application programmer interfaces or similar interface methods.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method of facilitating a payment comprising the steps of:
at a payment brokerage server, causing an authentication of a payer;
facilitating, by the brokerage server, a payer selection of at least one funding source and at least one real account associated with the payer;
obtaining, at the brokerage server, information identifying a payee;
receiving, at the brokerage server, an instruction from the payer instructing that the payment be made to the payee from at least one payer-selected funding source and at least one payer-selected real account;
obtaining, at the brokerage server, an approval from the at least one payer-selected funding source to make the payment; and
facilitating, by the brokerage server, the payment from the at least one payer-selected funding source to at least one real account of the payee to complete the payment transaction without divulging the at least one payer-selected funding source or the at least one payer-selected real account to the payee.

2. The method of claim 1, wherein the brokerage server communicates with the payer via wireless or wired network communication using a payer electronic device.

3. The method of claim 1, wherein the brokerage server communicates with the payee via wireless or wired network communication using a payee electronic device.

4. The method of claim 2, wherein the brokerage server communicates with the payee via wireless or wired network communication using a payee electronic device.

5. The method of claim 2, wherein the payer electronic device communicates with the payee electronic device via wireless or wired network communication.

6. The method of claim 3, wherein the payee electronic device communicates with the payer electronic device via wireless or wired network communications.

7. The method of claim 4, wherein the payer electronic device communicates with the payee electronic device via wireless or wired network communication.

8. The method of claim 1, wherein:
the brokerage server comprises or is in communication with at least one database comprising a plurality of records for payers and payees;
each payer record comprises authentication information and at least one funding source and one real account associated with the payer; and
each payee record comprises at least identification information associated with the payee.

9. The method of claim 1, wherein the brokerage server facilitates funding or transfer of the payment from at least one payer-selected funding source to at least one real account of the payment broker and from at the least one real account of the payment broker to at least one real account of the payee to complete the payment transaction without divulging the at least one payer-selected funding source or the at least one payer-selected real account to the payee.

10. The method of claim 1, wherein the brokerage server facilitates the funding or transfer of the payment from at least one payer-selected funding source to at least one real account of the payment broker and from at least one real account of the payment broker to the payee by issuance, by the payment broker, of at least one instrument of remittance or transfer and (i) mailing the instruments to the payee, (ii) delivering the instruments to the payee or (iii) holding the instruments for pick-up by the payee in order to complete the payment transaction without divulging the at least one payer-selected funding source or the at least one payer-selected real account to the payee.

11. A brokerage server for facilitating a payment comprising:
a communications module;
an authentication module for facilitating an authentication of a payer; and
a payment module for:
(i) facilitating a payer selection of at least one funding source and at least one real account associated with the payer;
(ii) obtaining information identifying a payee,
(iii) receiving an instruction from the payer instructing that the payment be made to the payee from at least one payer-selected funding source and at least one payer-selected real account;
(iv) obtaining an approval from the at least one payer-selected funding source to make the payment; and
(v) facilitating the payment from the at least one payer-selected funding source and the at least one payer-selected real account to at least one real account of the payee to complete the payment transaction without divulging the at least one payer-selected funding source or the at least one payer-selected real account to the payee.

12. The brokerage server in claim 11, further comprising a module for accessing at least one database comprising records specifying payers, payees, funding sources, real accounts, and authentication information.

13. The brokerage server of claim 11, wherein the payment module facilitates funding or transfer of the payment from at least one payer-selected funding source to at least one real account of the payment broker and from the at least one real account of the payment broker to at least one real account of the payee to complete the payment transaction without divulging the at least one payer-selected funding source or the at least one payer-selected real account to the payee.

14. The brokerage server of claim 11, wherein the payment module facilitates the funding or transfer of the payment from at least one payer-selected funding source to at least one real account of the payment broker and from at least one real account of the payment broker to the payee by issuance, by the payment broker, of at least one instrument of remittance or transfer and (i) mailing the instruments to the payee, (ii) delivering the instruments to the payee or (iii) holding the instruments for pick-up by the payee in order to complete the payment transaction without divulging the at least one payer-selected funding source or the at least one payer-selected real account to the payee.

15. A system for facilitating a payment comprising:
a electronic device running an application for authenticating or obtaining authentication information from a payer, obtaining payee-identifying information, and facilitating selection by the payer of at least one funding source and at least one real account associated with the payer;
a brokerage server for authenticating and identifying the payer based on the authentication information and requesting approval from the payer-selected funding source to make a payment; and
a funding-source server for receiving an authorization request and payment routing and clearing instructions and causing payment to be made to the payee to complete the payment transaction without divulging the at least one payer-selected funding source or the at least one payer-selected real account to the payee.

16. The system of claim 15, wherein the funding-source server causes the funding or transfer of the payment from at least one payer-selected funding source to at least one real account of the payment broker and from at least one real account of the payment broker to at least one real account of the payee to complete the payment transaction without divulging the at least one payer-selected funding source or the at least one payer-selected real account to the payee.

17. The system of claim 15, wherein the funding-source server facilitates the funding or transfer of the payment from at least one payer-selected funding source to at least one real account of the payment broker and from at least one real account of the payment broker to the payee by issuance, by the payment broker, of at least one instrument of remittance or transfer and (i) mailing the instruments to the payee, (ii) delivering the instruments to the payee or (iii) holding the instruments for pick-up by the payee in order to complete the payment transaction without divulging the at least one payer-selected funding source or the at least one payer-selected real account to the payee.
